(19) United States
(12) Patent Application Publication
(10) Pub. No.: US 2003/0061348 A1
(43) Pub. Date: Mar. 27, 2003

(54) System and method of providing information from a plurality of information sources

(76) Inventor: James W. Jacobs JR., Suwanee, GA (US)

Correspondence Address: MCKENNA LONG & ALDRIDGE LLP, 1900 K STREET, NW, WASHINGTON, DC, 20006, US

(21) Appl. No.: 09/960,320

(22) Filed: Sep. 24, 2001

(51) Int. Cl. G06F 15/173; G06F 15/16

(52) U.S. Cl. 709/225; 709/203

(57) ABSTRACT

A system for providing specific information to a user includes a subscription server. The subscription server collects metric information from a plurality of metric publication providers. A user may log into the subscription server and subscribe to receive a specific set of metric data from a variety of the metric publication providers. The user may define a user's view that presents only the metric data selected. A publication provider wishing to provide metric data via the subscription service send a message to the subscription server indicating which metric information it publishes. The publication provider provides the metric information in a standardized form to the subscription server. The publication provider may include an adapter that puts the metric information into standardized form.

### BACKGROUND OF THE INVENTION

1. Field of the Invention

The present invention relates to a system and method for providing information from a variety of sources through a single user interface. More particularly, the present invention relates to a system and method for providing a subscription based system for a plurality of computing systems, decision support systems, real cubes, virtual cubes, beacons, viewers and adapters.

2. Discussion of the Related Art

The way business is conducted is changing. The Internet has enabled this change to take place at a rapid pace. Decisions makers at all levels of an organization must have access to real time, dynamic, and ever changing information. Mergers, acquisitions, rapidly changing markets, and disparate computing systems companies, businesses face a significant challenge in getting information to the right people at the right time. There is an increasing need to put information into the hands of decision makers regardless of where or how the information is stored. The situation is complicated because the workforce is highly mobile, the people who make up the individual teams change, and the decision makers demand more and better information. Conventional methods of data replication, reporting, knowledge management, decision support and business intelligence do not meet the needs of today's workforce.

Most information gathering environments consist of transactional systems supplying standardized information to a report repository that users can query through a set means, for example via menus or standardized query templates. A company might use an accounting system to replicate account history into a data store or data warehouse that an analyst can access to determine a historical payment pattern. Such standardized and constrained methods meet the need of users that have the resources and time to rummage through past history to understand past performance, but such methods do not help decision makers managing a dynamic business in a real time environment. Too often, once a decision support system is in place, changes in the business are not reflected in the decision support system. The assumptions used to make the data warehouse or decision support system become outdated. Eventually, because the data is characterized in such a way that does not reflect current business practices, users find the data warehouse or decision support system useless and stop using the system. In some cases, continuous investment is required to routinely rebuild or retool the data warehouse to keep its characterization or presentation of data current.

In response to the growing demand for a more efficient means to collect, share, distribute, and act on information, distributed computing systems have become a much more attractive means of information processing. A “distributed computing system” can be defined as any number of systems or electronic platforms in which some form of data is stored, for example, in databases or electronic file systems, located in any number of locations, geographically distributed sites, or facilities. Because of technological advances in communications and microelectronics, as well as a decline in computer hardware costs, distributed computing systems have experienced prolific growth in the last decade. Distributed computing systems are now being utilized in complex system design and application-oriented issues, including such well known examples as on-line consumer purchasing, airline reservation systems, and on-line trading systems. While substantial research has been devoted to distributed computing systems, much work remains to facilitate effective implementations of distributed computing systems, particularly for dynamic decision support.

Historically, computer systems are designed and built to provide a focused solution to a specific problem. For example, entire computer systems are devised and dedicated to track accounting information. Often, the result is that a company eventually has many different systems that perform many different functions, with data stored in a variety of locations, often in a plurality of formats. Such multi-platform systems give rise to the current situation where a decision maker may have great difficulty in getting relevant and timely information in a usable format.

Many computer systems provide more than just one function. However, few if any such computer systems provide integrated business information across multiple platforms or variously formatted data warehouse systems. Problems associated with heterogeneous data storage, heterogeneous interfaces, heterogeneous computing systems and distributed locations have significantly hampered true business information integration.

Conventional solutions to the multi-platform, multi-format environment entail the replication of vast quantities of data into customized data structures. These data structures are often predefined and rigid. These data structures are often developed based on assumptions about a business and how the stored data will be used. Once the data structure is determined, the assumptions about a business are set. Because modifying the data structure might involve re-processing or reformatting already-stored data or, worse still, might render the previously stored data obsolete, data structures do not evolve as the business model evolves. The effort required to keep a data warehouse from becoming stale is expensive in terms of dollars spent for analysts and programmers as well as the tedious process of change. New assumptions and new systems need certification and recertification. Changing market conditions, a new acquisition, or any business change may invalidate the data warehouse. The expense of updating the system may mean management does not fund the upkeep of the system. This is a significant and pervasive problem.

To get to the data, most companies add a report writing engine onto their data warehouse software. It is left to the user or an analyst to build meaningful reports using the data warehouse software. The reports are then available to users whenever the user remembers to run one. When users want new or different reports, they must invest in new development or modification of the data warehouse software to build reports. Such report development cycle have impeded vast implementation of data supported decision support systems. The inability of data warehouses to maintain and generate meaningful data in real-time make such systems incapable of supporting decision making. Decision makers need relevant information, not reports.

### SUMMARY OF THE INVENTION

Accordingly, the present invention is directed to a system and method of providing information from a plurality of information sources that substantially obviates one or more of the problems due to limitations and disadvantages of the related art.

An object of the present invention is to provide a system that provides a single interface for a user to receive usable metric data and key performance indicators in a standardized format from a plurality of information sources.

Another object of the present invention is to provide a method for providing to a user usable metric data and key performance indicators in a standardized format from a plurality of sources.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method for providing key performance indicators to a subscriber via a subscription server and subscriber interface, includes presenting a subscriber interface; identifying in the subscriber interface subscriptions available from a plurality of information sources; selecting a subset of the subscriptions in response to input from the subscriber interface; identifying a key performance indicators available from the subset of subscriptions; selecting key performance indicators from the selected subset of subscriptions in response to input from the subscriber interface; and providing the selected key performance indicators via the user interface.

In another aspect of the present invention, a system for providing metric information to a subscriber, includes a subscription server for receiving information from a plurality of information sources in a standardized format, the subscription server having a user interface; and at least one communication connection by which the subscription server is capable of being contacted by a user and by which the subscription server is capable of receiving information from a plurality of information sources, wherein the user interface allows the user to select a subset of the information sources, the information sources remote from the subscription server and the subscription server receiving metric information from the information sources.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating an embodiment of the system of the present invention.

FIG. 2 is a flow chart illustrating an embodiment of the method of the present invention.

FIG. 3 is a block diagram illustrating another embodiment of the present invention.

FIG. 4 is a block diagram illustrating an example of a subscription server contacting adapters at publications providers directly or via another subscription server.

FIG. 5 is a flow chart illustrating the relationship of publishing providers and a subscription server of the present invention.

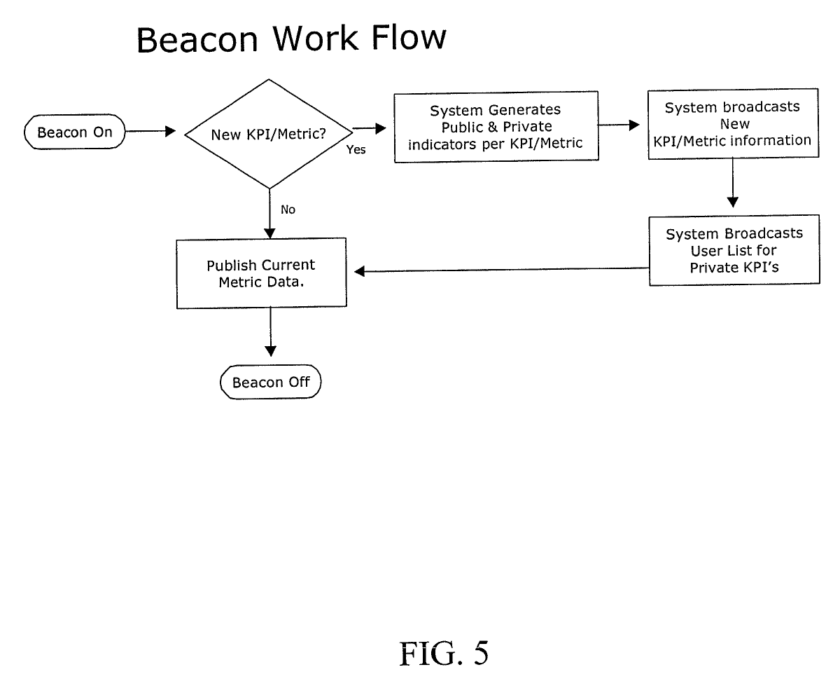

### DETAILED DESCRIPTION OF THE PREFERRED EMBODIMENTS

Reference will now be made in detail to the preferred embodiment of the present invention, example of which is illustrated in the accompanying drawings.

The method of the present invention enables a user to get information from a plurality of different systems through a single interface. A user need only connect to a single subscription system to gather meaningful data in real time without having to connect separately to each of a plurality of distributed computing systems. The system increases the number of systems from which a user can get information, reduces the number of interfaces required to get heterogeneous information, and enables a person to get information from any system enabled to work with the subscription system. The system allows a user to get heterogeneous information from a plurality of systems via the subscription service and provides a process by which a user can subscribe to public, semi private, private and other types of subscriptions. The system also insulates the user from the complexity of connecting to, integrating with, assimilating, and presenting heterogeneous information from a plurality of systems.

The system of the present invention may be used on any of a variety of communication media.

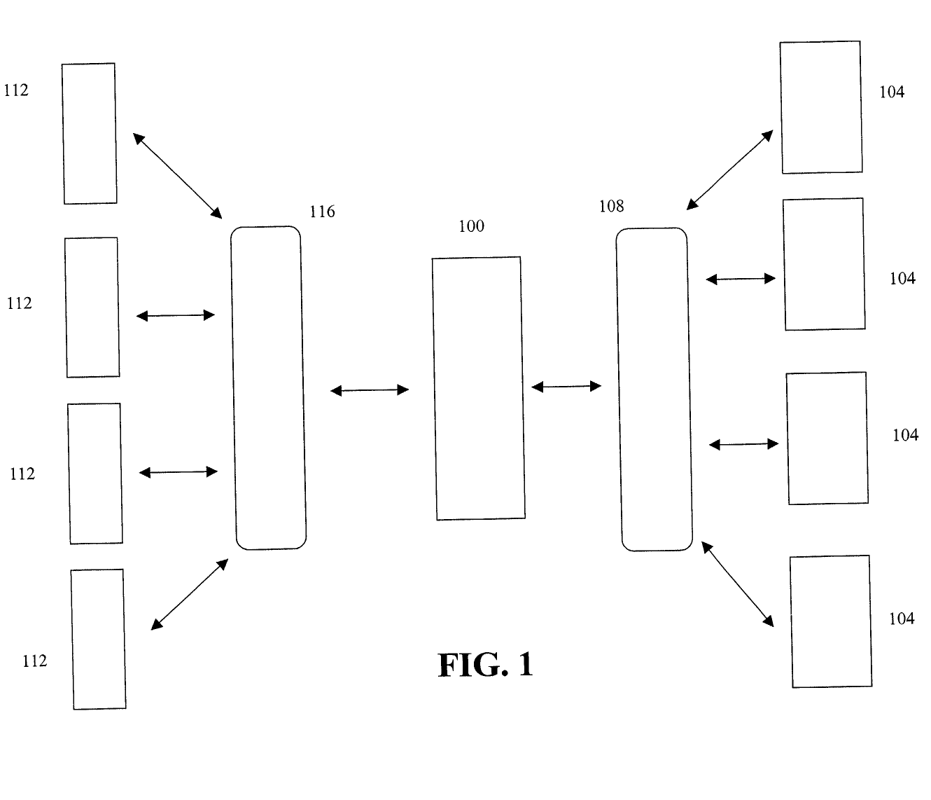

As shown in FIG. 1, a subscription server 100 is capable of transmitting and receiving signals to a plurality of users 104. Such communication may occur through any of a variety of communication media 108, including the Internet, an Intranet, a direct telephone dial up connection, a wireless connection, or any other known means. The subscription server 100 is also in communication with a variety of publication providers 112. Such communication may occur through any of a variety of communication media 116, including the Internet, an Intranet, a direct telephone dial up connection, a wireless connection, or any other known means. Preferably, the communication between the subscription server 100 and the publication providers 112 occurs via the Internet.

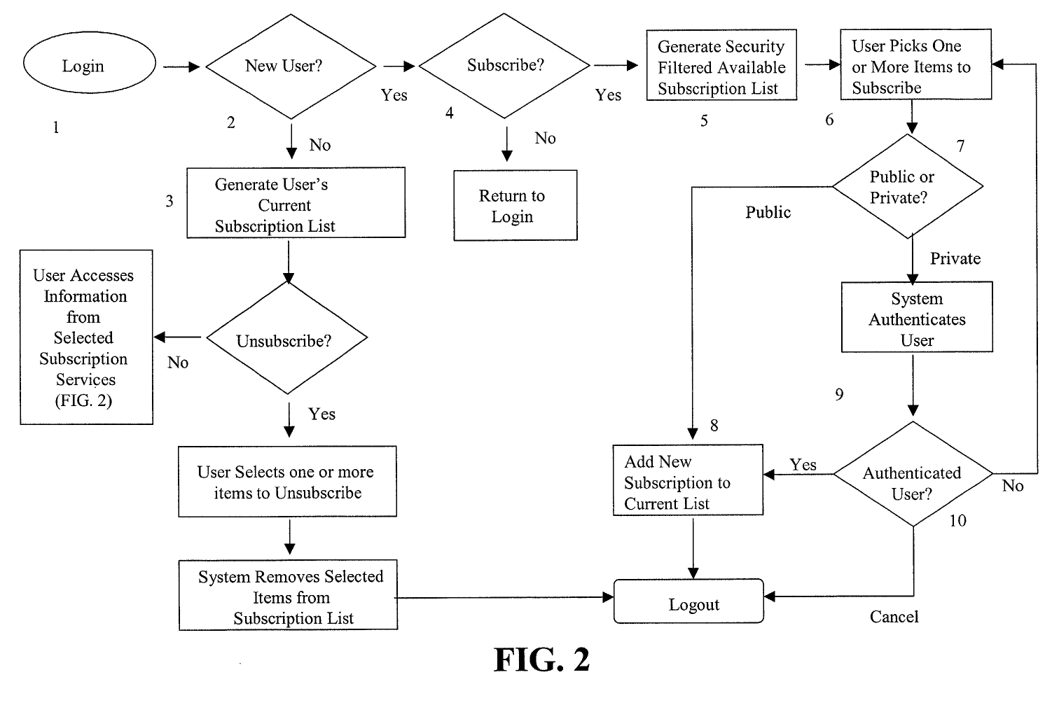

Referring to FIGS. 1 and 2, operation of the present system will be described. At step 1, a user logs into a system of the present invention. That is, the user 104 begins communication with the subscription server 100. Such communication occurs through the communication media 108. At step 2, the subscription server 100 determines if the user 104 is a new user or a returning subscriber. If the user 104 is a returning subscriber, the subscription server 100 checks to see if the user 104 is logging in to unsubscribe to a service. If the user 104 does not wish to unsubscribe, the user 104 is able to access any subscription on a current subscription list (not shown) that has been defined for the user in a previous login session, a shown as step 3.

If the user 104 is not a returning subscriber, the subscription server 100 allows the user 104 to perform a process to subscribe to the subscription service, at step 4. The subscription server 100 provides a list of available subscriptions from which the subscriber can choose, at step 5. The user 104 can choose from an available list of public, semi-private, private and any other type subscriptions. The available list corresponds to a set of subscriptions available from the publishing providers 112 that the subscription server 100 recognizes as providing subscription services. Public subscriptions services are those services that do not require any authorization prior to access being granted. The user 104 can subscribe to a public subscription service by choosing one or more of the public subscription services listed in the available list, as represented by step 6. Semi-private subscriptions are those systems that can be accessed by a user 104 by registering with the subscription service. Registration to a semi-private subscription may be limited to users meeting certain criteria, including payment of a fee. Private subscription services are those subscription services that have a closed list of users. For example, a company-specific service might only allow access to the information contained therein to company employees or officers.

In addition, user-defined subscriptions are available as well. A user can define access rules, authorization rules, publication rules, time windows, and other rules which, when combined form a specific subscription type. In order for a person to subscribe to a user-defined subscription the person must go through the same steps as a private subscription in that the person must be authorized and pass the rules set forth in the subscription.

The subscription server determines if the user has selected a public, semi-private or private subscription service from the available list at step 7. If the user selects a public subscription service, the public service is added to the user's current subscription list at step 8. If during the subscription process, a user selects a semi-private or private subscription service, the system will authenticate the user to determine if the user is allowed access to the semi-private or private subscription service at step 9. If access is denied, the procedure is canceled and the user is logged out or the user is returned to the subscription list to register for another available subscription at step 10. A subscriber's access to any type subscription services may be subject to expiration under certain criteria.

When a subscribed user 104 logs in to the subscription server 100, the subscription server 100 will match the subscribed user 104 with their subscribed to list for both private and public subscriptions. Actual subscription to a subscription service is performed at a publication provider. Each publication provider 112 maintains a current list of subscriptions available from that publication provider. Each subscription service is marked as public, semi-private, or private. Only public and authorized private and authorized semi private subscriptions can be viewed by a particular user.

A publication provider presents its information to the subscription network in a standardized form. For example, for providing decision support information, a publication provider provides Key Performance Indicators (KPIs). Each KPI provides specific information pertaining to a specific subject in grouped or compiled form. The KPI is a way of expressing business information. From within each subscription service, one or more KPIs may be available. When a user subscribes to a subscription service, the KPIs provided by that subscription service become available to the user. The user may select which KPIs from a subscription service to which the user subscribes are to be provided to the user. The subscription server assigns the selected KPIs to a subscriber's view, which is provided as an interface to the user upon logging in to the subscription server. The selected KPIs will remain in the subscriber's view until the subscriber deselects a specific KPI or unsubscribes to the subscription service that provides a given KPI.

If a subscriber subscribes to a private subscription, the system must authenticate the subscriber as being authorized to view the KPIs for this private subscription. Upon authentication, the server system will assign the selected KPIs to the subscriber's view. It is possible that a subscriber may be authenticated for some KPIs provided by a private or semi-private subscription service, but may not be authenticated for other KPIs on the same subscription service. Within a KPI there are multiple types of metrics including public and private metrics.

A user subscription list contains at least one subscription and at least one selected KPI. Once a subscription is established, the subscription server builds a user view that can represent any or all of the user's subscriptions by invoking a build command. The build command builds the user view by first compiling a KPI/metric list and then getting all of the KPI/metric information from the publication providers.

The subscription server contains pertinent information to direct the build command to the KPI/metric information located on any of a plurality of publication provider servers. The user does not have to identify the location of the data. The user only needs to choose the KPI/metric they wish to have information on. The subscription server will take a request for information via a subscription and match the request to the appropriate subscription service and associated publication provider.

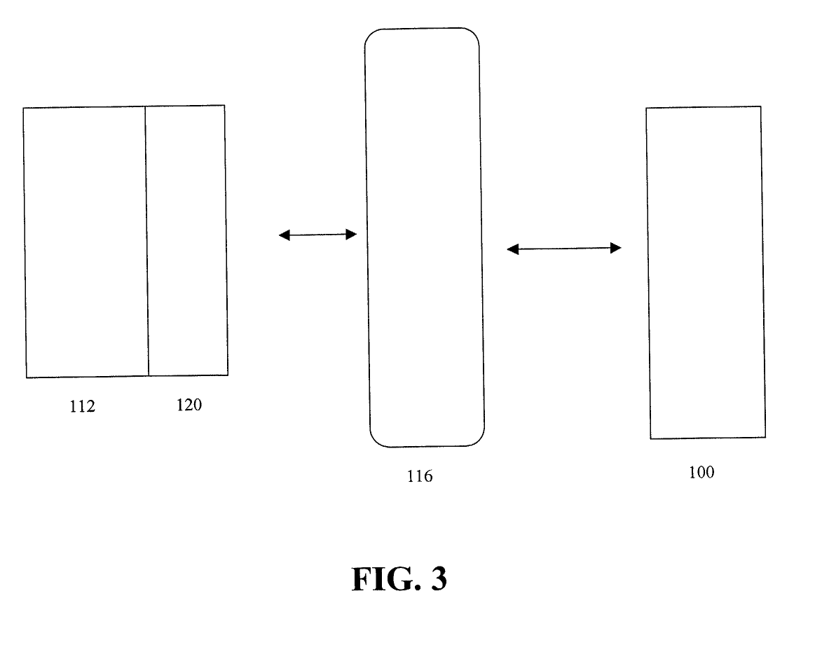

As represented in FIG. 3, to allow the subscription server 100 to locate information provided by a particular publication provider 112, the publication provider server 112 is equipped with an adapter 120. The adapter 120 provides the basic interface, transformation and beacon capabilities. The beacon lets subscription server 100 know that the publication provider 112 exists, what KPIs it can publish, and what metrics it can publish. The beacon is also responsible for indicating if these KPI/metrics are public or private or semi-private.

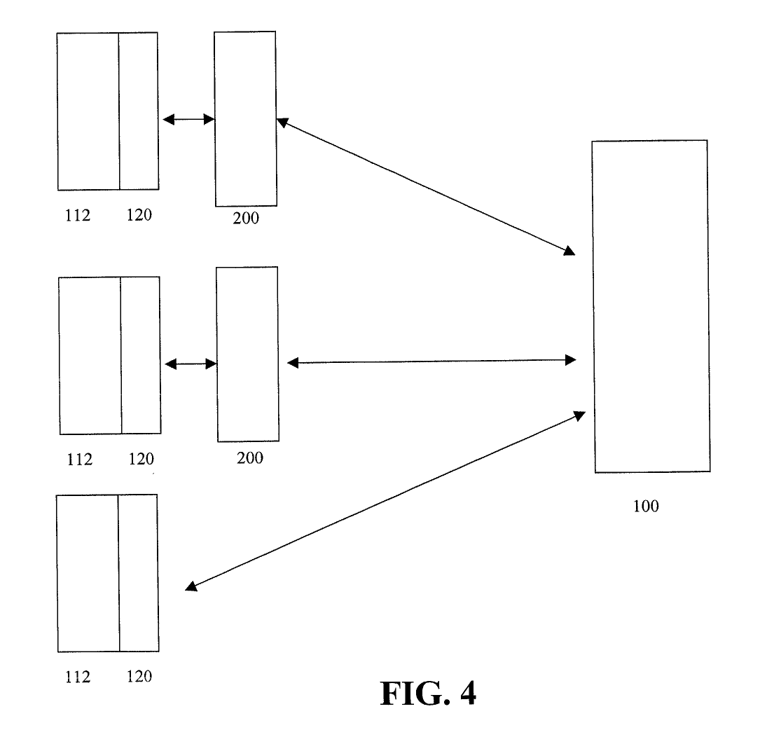

As shown in FIG. 4, a subscription server 100 can communication with other subscription servers 200. It is not required that a subscription server 100 have direct access to all adapters 120 associated with publication providers. Instead, a user's subscription may literally be a collection of communications directly from adapters 120 and directly from other subscription servers 200 which then in turn communicate with adapters 120. A subscription server 100 that interfaces with a user will contain a list of available subscriptions and the method for implementing the retrieval of data. The user 104 will not be aware of the actual implementation path or method. Thus, once a user 104 has selected a given KPI and Metric, the subscription server 100 may then perform the authorization directly or pass the information to another subscription server 200 which in turn performs the authorization.

As shown by the flow chart of FIG. 4, a publication provided publishes KPI and metric data by turning on the beacon at step 41. If the KPI or metric is not new, the publication provider simply publishes or broadcasts the KPI or metric at step 42. If publication provider 112 publishes a new KPI or metric, at step 43 the publication provider 112 creates an indicator to indicate whether the new KPI or metric is public, private or semiprivate. Already created KPIs and metrics would already contain such an indicator. For the new KPI or metric, the publication provider 112 then uses the adapter 120, including the beacon, to broadcast the new KPI or metric with the indicator and a user list for the KPI or metric if indicator indicates that the new KPI or metric is private or semi-private at steps 44 and 45. The broadcast is made via the communication media 116, which is preferably the Internet or World Wide Web.

The user 104 is unaware that information provided by the subscription server is generated by multiple publication providers. The user sees a single interface. For example, when using the Internet as the communication media between the user and the subscription server, the user simply uses a Web browser to go to a Web site to subscribe, unsubscribe or access subscription service information. The system then figures out how, when, what is available, and what to do with the information.

The present invention reduces the expense of administration of various interrelated entities or organizations that need to communicate data, through process automation, information flow, personnel utilization and integrated systems use and increases the quality of decision making by providing decision makers with timely and relevant report information, thus reducing duplication efforts that result from maintenance of plural, heterogeneous databases associated with businesses. The present system provides a distributed database system that allows system users to have access to new data sources as they come on-line, without requiring the users or their systems to know the routing address or other identifying information about the new data source.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for providing key performance indicators to a subscriber via a subscription server and subscriber interface, comprising:
presenting a subscriber interface;
identifying in the subscriber interface subscriptions available from a plurality of information sources;
selecting a subset of the subscriptions in response to input from the subscriber interface;
identifying key performance indicators available from the subset of subscriptions;
selecting key performance indicators from the selected subset of subscriptions in response to input from the subscriber interface; and
providing the selected key performance indicators via the user interface.

2. The method of claim 1, further comprising:
maintaining a record the selected key performance indicators.

3. The method of claim 2, further comprising:
updating the record of selected metric data if an information source corresponding to the metric data updates the metric data.

4. The method of claim 1, wherein the key performance indicators are maintained on at least one of the information sources separate from the subscription server.

5. The method of claim 4, wherein the subscription server receives key performance indicators from the information sources via a communication media.

6. The method of claim 5, wherein the communication media is the Internet.

7. A method for providing data to a subscriber via a subscription server and user interface, comprising:
presenting a user interface;
identifying in the user subscriber interface data available from a plurality of information sources;
selecting a subset of the data in response to input from the user interface;
identifying metric data available from the subset of data;
selecting metric data from the selected subset of data in response to input from the user interface; and
providing the selected metric data via the user interface.

8. The method of claim 7, further comprising:
maintaining a record of the selected metric data.

9. The method of claim 8, further comprising:
updating the record of selected metric data if an information source corresponding to the metric data updates the metric data.

10. The method of claim 7, wherein the key performance indicators are maintained on at least one of the information sources separate from the subscription server.

11. The method of claim 10, wherein the subscription server receives key performance indicators from the information sources via a communication media.

12. The method of claim 11, wherein the communication media is the Internet.

13. A system for providing metric information to a subscriber, comprising:
a subscription server for receiving information from a plurality of information sources in a standardized format, the subscription server having a user interface; and
at least one communication connection by which the subscription server is capable of being contacted by a user and by which the subscription server is capable of receiving information from a plurality of information sources,
wherein the user interface allows the user to select a subset of the information sources, the information sources remote from the subscription server and the subscription server receiving metric information from the information sources.

14. The system of claim 13, wherein the metric information is a key performance indicator.

15. The system of claim 13, wherein the at least one communication connection is made to the subscription server via the Internet.

16. A system for providing metric information to a subscriber, comprising:
a plurality of first subscription servers for receiving information from at least one first information source in a standardized format,
at least one first communication path by which at least one of the first subscription servers is capable of receiving information from the at least one first information source in a standardized format;
a second subscription server for receiving information from at least one of the first subscription servers, the second subscription server having a user interface; and
at least one second communication path connection by which the second subscription server is capable of being contacted by a user
wherein the user interface allows the user to select a set of information sources from the first information source and second information sources, the second information sources remote from the second subscription server.

17. The system of claim 16, wherein the at least one first communication path is the Internet

18. The system of claim 16, wherein the at least second communication path is the Internet.

19. A method for providing data to a subscriber via a subscription server and user interface, comprising:
presenting a user interface;
identifying in the user subscriber interface data available from a plurality of information sources;
selecting a subset of the data in response to input from the user interface;
identifying metric data available from the subset of data;
selecting metric data from the selected subset of data in response to input from the user interface;
receiving the selected metric data; and
providing the selected metric data via the user interface.

20. The method of claim 19, wherein the selected metric data is received directly from one of a remote subscription server and the information sources.
